(19) United States
(12) Patent Application Publication
(10) Pub. No.: US 2026/0290008 A1
(43) Pub. Date: Sep. 24, 2026

(54) SYSTEM FOR BLENDING A FRAGRANCE

(71) Applicant: SoftBank Group Corp., Tokyo (JP)

(72) Inventor: Kenichi YAMAZAKI, Tokyo (JP)

(21) Appl. No.: 19/568,809

(22) Filed: Mar. 17, 2026

Related U.S. Application Data
(60) Provisional application No. 63/774,781, filed on Mar. 20, 2025.

(51) Int. Cl. G06V 20/20; G06F 3/01; G06N 3/0475; G10L 15/22; G10L 21/0208

(52) U.S. Cl. CPC G06V 20/20; G06F 3/013; G06N 3/0475; G10L 15/22; G10L 21/0208; G10L 2015/223

(57) ABSTRACT

The present disclosure relates to a system that acquires surrounding voice and visual information in real time using earphones and contact lenses worn by a user, and provides information according to the user's request by utilizing artificial intelligence. A voice acquisition unit captures voice using a high-sensitivity microphone and removes unnecessary sound with noise canceling technology. A visual acquisition unit acquires an image using a small camera and identifies a gazed-at object with eye-tracking technology. A prompt analysis unit analyzes an oral prompt, and an information generation unit generates related information. An information provision unit provides information using synthesized voice or a retinal projection function.

### CROSS-REFERENCE TO RELATED APPLICATION

This application claims the benefit of priority from U.S. Provisional Patent Application No. 63/774781, filed on Mar. 20, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is a problem that it is difficult for a user to efficiently collect a vast amount of information encountered in daily life and to quickly and accurately acquire necessary information. In modern society, the amount of information continues to increase, and although users are exposed to a lot of information visually and audibly, it is not easy to immediately understand and utilize it. In particular, when a user needs specific information, it takes time and effort to manually search for and acquire that information. This disclosure aims to dramatically improve the efficiency of information acquisition by using earphones and contact lenses to collect information that a user sees and hears in real time, and by utilizing artificial intelligence to immediately provide information according to the user's request. This enables the user to quickly obtain necessary information and to make appropriate decisions even in situations of information overload. Furthermore, it aims to improve user convenience and make the information acquisition process more intuitive and natural through the provision of visual and auditory information.

As a means for solving the problem, the present disclosure provides a system including a voice acquisition unit that acquires voice information, a visual acquisition unit that acquires visual information, a prompt analysis unit that analyzes an oral prompt from a user, an information generation unit that generates information based on an analysis result, and an information provision unit that provides the generated information to the user. In this system, the voice acquisition unit captures surrounding voice in real time using a high-sensitivity microphone and removes unnecessary sound using noise canceling technology. The visual acquisition unit captures images entering the user's field of view in real time using a small camera and has a function of tracking the user's eye movements. The prompt analysis unit analyzes an oral prompt uttered by the user using natural language processing technology, and the information generation unit generates related information based on the analyzed prompt. The information provision unit provides the generated information to the user either by voice through earphones or visually through a retinal projection function of contact lenses, according to the user's selection. In this way, the user can quickly and accurately obtain necessary information based on the visually and audibly acquired information, and the efficiency of information acquisition can be significantly improved.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a multimodal data processing and information provision method.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

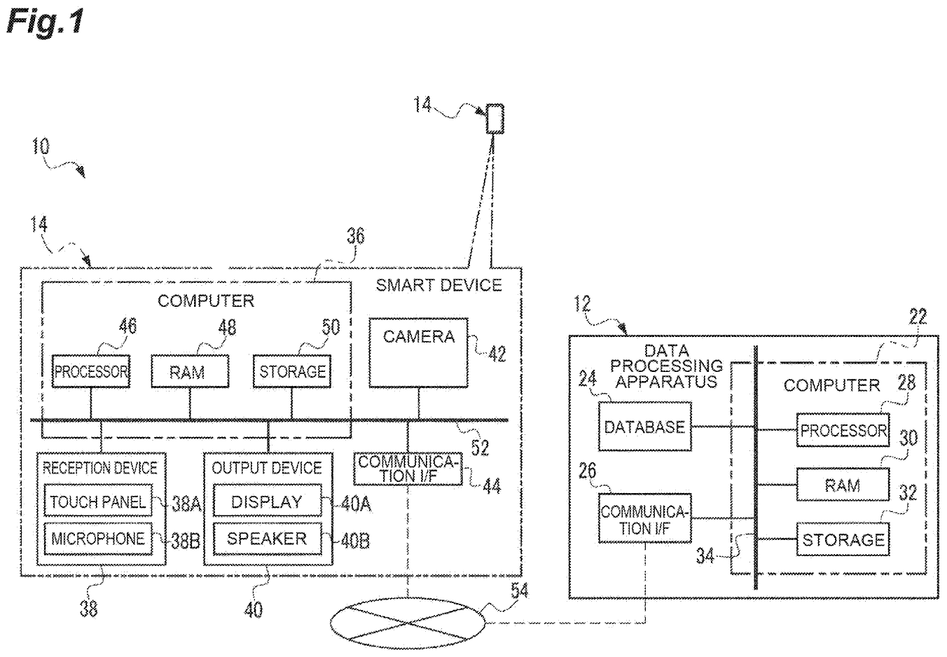

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

Furthermore, the smart device 14, smart glasses 214, headset-type terminal 314, and robot 414 (hereinafter collectively referred to as edge devices) have an edge computing function that performs preprocessing on acquired raw data (Raw Data) before transmitting data to the data processing apparatus 12 (cloud server). Specifically, the processor 46 cuts out only a region of interest (ROI: Region of Interest) intersecting with the user's gaze vector from the video data acquired by the camera 42, compresses it, and transmits it. At the same time, a voice acquisition unit such as the microphone 38B emphasizes a sound source in the direction of the gaze vector using beamforming technology, filters environmental sounds in other directions, and then generates voice data. This makes it possible to reduce the bandwidth consumption of the network 54 while suppressing the latency (delay) of inference processing in the data processing apparatus 12 to a threshold value (for example, less than 200 milliseconds) at which a human does not feel uncomfortable. Unlike general data collection, this processing is a specific technical improvement based on hardware synchronization control of a visual sensor and an auditory sensor.

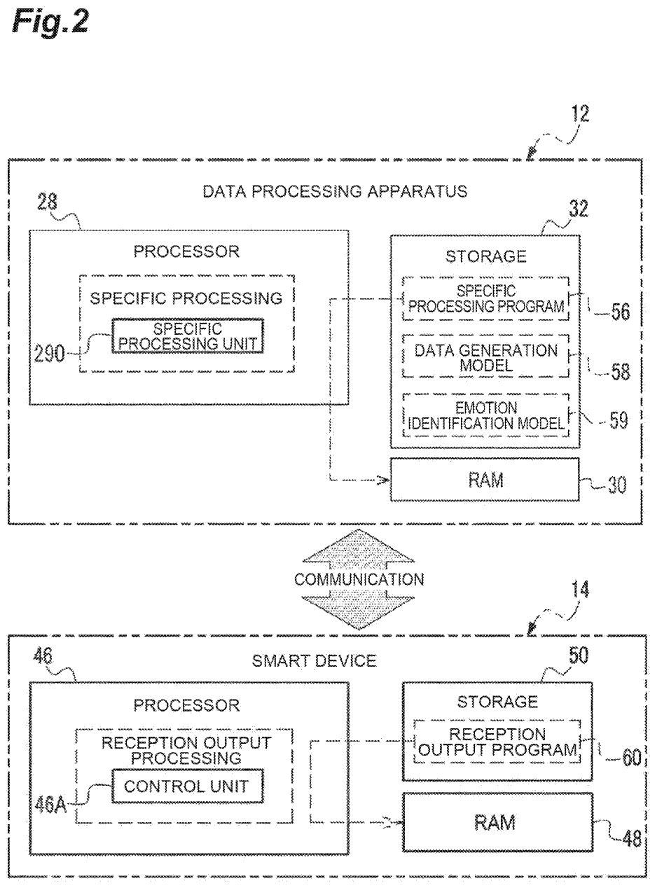

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### EXAMPLE 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

An embodiment will be described more specifically and in detail. This system is composed of a terminal worn by a user and a server that performs information processing. The terminal is a wearable device including earphones and contact lenses, and the server is a cloud-based information processing system.

First, a voice acquisition unit in the terminal captures the user's surrounding voice in real time using a high-sensitivity microphone built into the earphones. The voice input unit may be configured by, for example, the reception device 38 and the microphone 238. This microphone can be made directional to effectively acquire intended voice from the user. For example, when a user is conversing with a friend in a cafe, surrounding noise can be eliminated to clearly acquire the conversation content. Noise canceling technology analyzes surrounding environmental sound in real time and dynamically removes unnecessary sound. This voice data is transmitted to the server using wireless communication technology such as Bluetooth or Wi-Fi.

Next, a visual acquisition unit captures images entering the user's field of view in real time using an ultra-small camera built into the contact lenses. The voice input unit may be configured by, for example, the reception device 38 and the camera 42. This camera has a function of tracking the user's eye movements and can identify an object that the user is gazing at using eye-tracking technology. For example, when a user is looking at a specific painting in a museum, an image of that painting is acquired in high resolution, and detailed information is transmitted to the server. This visual data is also transmitted to the server using wireless communication technology.

On the server, a prompt analysis unit that has received voice information from the voice input unit and video information from the visual acquisition unit analyzes an oral prompt from the user using natural language processing technology. The prompt analysis unit may be configured by, for example, the specific processing unit 290, the specific processing program 56, the data generation model 58, and the emotion identification model 59. It converts voice data into text using speech recognition technology and utilizes machine learning algorithms to understand the user's intention. For example, when the user makes a request such as “Who is the architect of this building?”, the server analyzes the voice data and understands the user's intention. Based on the analysis result, an information generation unit generates related information. The prompt analysis unit may be configured by, for example, the specific processing unit 290, the specific processing program 56, the data generation model 58, and the emotion identification model 59. The information generation unit refers to databases and knowledge bases on the Internet to collect and generate information about the architect of the building. This process uses search engine technology and data mining technology.

The analysis processing by the prompt analysis unit is executed according to the following specific algorithm. First, the acquired voice data is input to a neural network including an acoustic model (Acoustic Model) and a language model (Language Model), and converted into text data. Next, natural language processing (NLP) using a Transformer architecture is applied to the converted text data. Here, each word in the text is vectorized (Embedding), and keywords related to the user's intention (e.g., “architect”, “history”) are weighted using an attention mechanism (Attention Mechanism). Furthermore, object recognition processing using a convolutional neural network (CNN) is also performed on the image data obtained from the visual acquisition unit, and tag information of the recognized object (e.g., “building”, “painting”) is vectorized. The prompt analysis unit concatenates the vector derived from voice and the vector derived from the image to generate a multimodal context vector. By searching the database 24 or an external knowledge base using this context vector as a query, ambiguity of information that cannot be identified by a single modality (voice only or image only) is eliminated.

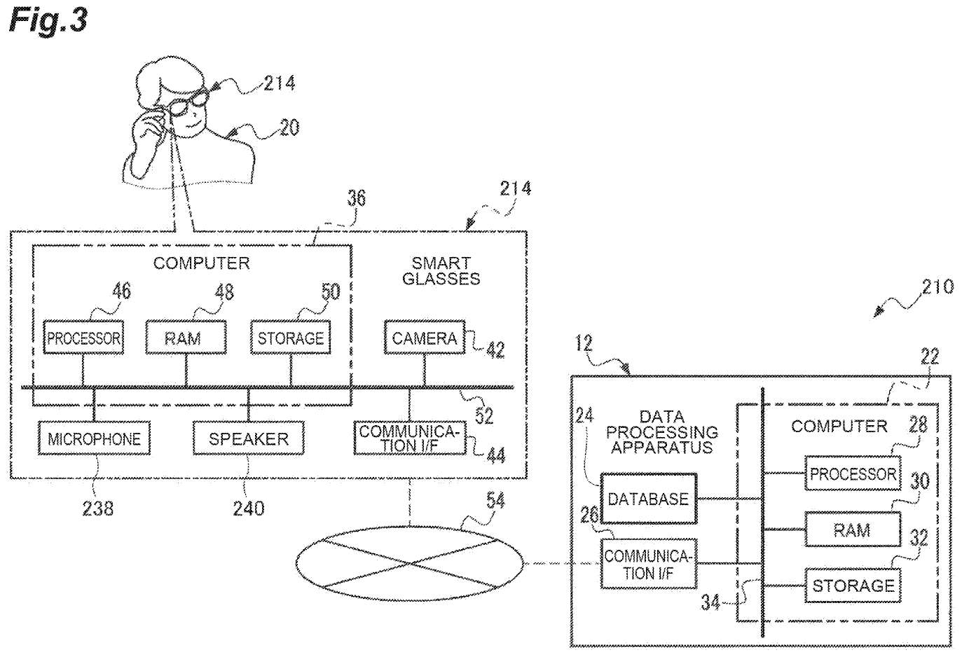

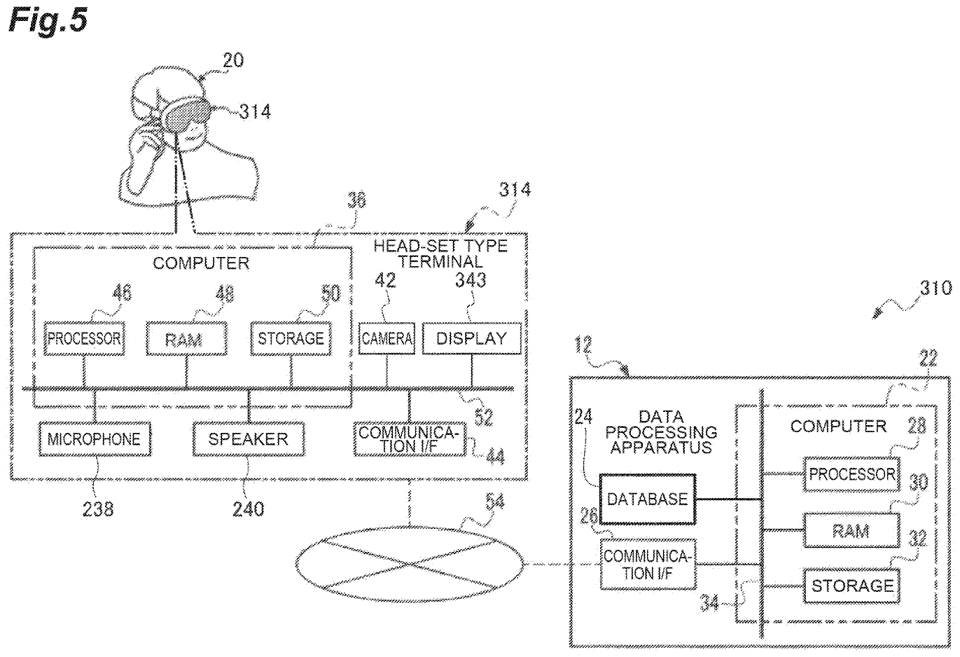

The generated information is provided to the user through an information provision unit. The information provision unit may be configured by, for example, the output device 40, the speaker 40, and the display 343. In the terminal, the information is provided by voice using synthesized speech technology through the earphones (a type of speaker 40, 40B), or visually through a retinal projection function (a type of display 343, 40A) of the contact lenses. In the case of information provision by voice, the information is conveyed in a natural voice using text-to-speech technology. In the case of visual information provision, the information is directly projected into the user's field of view using display technology mounted on the contact lenses. For example, when the user selects information provision by voice, the information is conveyed in a natural voice from the earphones. When visual information provision is selected, the information is directly projected into the user's field of view using display technology mounted on the contact lenses. Although examples of smart glasses 214 are shown in FIG. 3 and a headset 314 is shown in FIG. 5, as a modification of these smart glasses 214 and headset 314, contact lenses equipped with a display having the retinal projection function may be applied as a wearable device used by the user.

Here, the retinal projection function by contact lenses will be described in detail. This function is realized by an ultra-small micro LED array or a laser light source (e.g., RGB semiconductor laser) sealed inside the base material of the contact lens, and a holographic optical element (HOE: Holographic Optical Element) or a light guide path that diffracts and guides light. A drive circuit that has received a video signal from the control unit 46A modulates the light source and converges the emitted light flux toward the center of the user's pupil via the HOE. As a result, the principle of “Maxwellian View” is applied, in which a clear image is always formed directly on the retina regardless of the accommodation state (focusing) of the crystalline lens. With this method, the user can perceive clear AR (Augmented Reality) information superimposed on the scenery of the real world (external light) without being affected by visual acuity while visually recognizing the scenery. In addition, these electronic components are connected by a transparent conductive material and are driven by wireless power supply from the outside or tear fluid power generation.

In this way, the present disclosure enables a user to quickly and accurately obtain necessary information based on visually and audibly acquired information, and can significantly improve the efficiency of information acquisition. As a specific example, various use cases can be considered, such as when a user wants to know the history of a tourist spot while traveling, when a user wants to know the meaning of a specific term immediately during a meeting, or when a user wants to check detailed information of a product while shopping. This enables the user to make appropriate decisions even in situations of information overload.

### (System Configuration)

The system according to the present embodiment includes a voice acquisition unit, a visual acquisition unit, a prompt analysis unit, an information generation unit, and an information provision unit. The voice acquisition unit has a built-in high-sensitivity microphone for capturing the user's surrounding voice in real time. This microphone can be made directional to effectively acquire voice from a specific direction. For example, when a user is conversing with a friend in a cafe, surrounding noise can be eliminated to clearly acquire the conversation content. Also, by using noise canceling technology, environmental sounds such as on a busy road or at a crowded event venue can be analyzed in real time, and unnecessary sounds can be dynamically removed. Furthermore, the voice acquisition unit is provided with a function of transmitting the acquired voice data to a server using wireless communication technology such as Bluetooth or Wi-Fi.

The visual acquisition unit has a built-in ultra-small camera for capturing images entering the user's field of view in real time. This camera has a function of tracking the user's eye movements and can identify an object that the user is gazing at using eye-tracking technology. For example, when a user is looking at a specific painting in a museum, an image of that painting is acquired in high resolution, and detailed information is transmitted to the server. Also, the visual acquisition unit can scan a product label while the user is shopping and acquire detailed information about the product. Furthermore, the visual acquisition unit is provided with a function of transmitting the acquired visual data to the server using wireless communication technology.

The prompt analysis unit analyzes an oral prompt from the user using natural language processing technology. It converts voice data into text using speech recognition technology and utilizes machine learning algorithms to understand the user's intention. For example, when the user makes a request such as “Who is the architect of this building?”, the prompt analysis unit analyzes the voice data and understands the user's intention. Also, when the user makes a request such as “Tell me the reviews for this product,” the prompt analysis unit generates a prompt for searching for related information. Furthermore, the prompt analysis unit can generate a specific prompt sentence for a generative AI, such as “Explain the historical background of this painting in detail.”

The information generation unit generates related information based on the analysis result from the prompt analysis unit. The information generation unit refers to databases and knowledge bases on the Internet to collect and generate necessary information. For example, when the user makes a request such as “Who is the architect of this building?”, the information generation unit collects information about the architect of the building and provides it to the user. Also, when the user makes a request such as “Tell me the reviews for this product,” the information generation unit collects review information for the product and provides it to the user. Furthermore, the information generation unit can generate detailed information by using a specific prompt sentence for a generative AI, such as “Explain the historical background of this painting in detail.”

The information provision unit provides the generated information to the user. The information provision unit provides the information by voice using synthesized speech technology through earphones, or visually through a retinal projection function of contact lenses. For example, when the user selects information provision by voice, the information provision unit conveys the information in a natural voice from the earphones. Also, when the user selects visual information provision, the information provision unit directly projects the information into the user's field of view using display technology mounted on the contact lenses. Furthermore, the information provision unit can provide the information in an optimal format according to the information provision method selected by the user.

### (Implementation Steps)

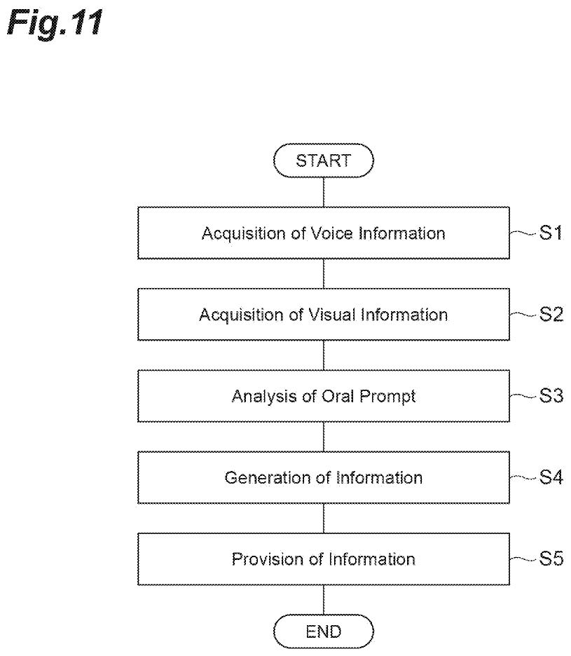

### Step 1: Acquisition of Voice Information (see Step S1 in FIG. 11)

Surrounding voice is captured in real time using a high-sensitivity microphone built into earphones worn by the user. This microphone can be made directional to effectively acquire voice from a specific direction. For example, when a user is conversing with a friend in a cafe, surrounding noise can be eliminated to clearly acquire the conversation content. Also, by using noise canceling technology, environmental sounds such as on a busy road or at a crowded event venue can be analyzed in real time, and unnecessary sounds can be dynamically removed. The acquired voice data is transmitted to a server using wireless communication technology such as Bluetooth or Wi-Fi.

### Step 2: Acquisition of Visual Information (see Step S2 in FIG. 11)

An ultra-small camera built into contact lenses is used to capture images entering the user's field of view in real time. This camera has a function of tracking the user's eye movements and can identify an object that the user is gazing at using eye-tracking technology. For example, when a user is looking at a specific painting in a museum, an image of that painting is acquired in high resolution, and detailed information is transmitted to the server. Also, a user can scan a product label while shopping and acquire detailed information about the product. The acquired visual data is also transmitted to the server using wireless communication technology.

### Step 3: Analysis of Oral Prompt (see Step S3 in FIG. 11)

An oral prompt from the user is analyzed using natural language processing technology. Speech recognition technology is used to convert voice data into text, and machine learning algorithms are utilized to understand the user's intention. For example, when the user makes a request such as “Who is the architect of this building?”, the voice data is analyzed to understand the user's intention. Also, when the user makes a request such as “Tell me the reviews for this product,” a prompt for searching for related information is generated.

### Step 4: Generation of Information (see Step S4 in FIG. 11)

Related information is generated based on the analysis result from the prompt analysis unit. The information generation unit refers to databases and knowledge bases on the Internet to collect and generate necessary information. For example, when the user makes a request such as “Who is the architect of this building?”, information about the architect of the building is collected and provided to the user. Also, when the user makes a request such as “Tell me the reviews for this product,” review information for the product is collected and provided to the user. For a generative AI, a specific prompt sentence such as “Explain the historical background of this painting in detail” is used.

### Step 5: Provision of Information (see Step S5 in FIG. 11)

The generated information is provided to the user. The information provision unit provides the information by voice using synthesized speech technology through earphones, or visually through a retinal projection function of contact lenses. For example, when the user selects information provision by voice, the information is conveyed in a natural voice from the earphones. Also, when the user selects visual information provision, the information is directly projected into the user's field of view using display technology mounted on the contact lenses. The information provision unit can provide the information in an optimal format according to the information provision method selected by the user.

### (Specific Use Case)

For example, when a user visits a historical tourist spot, by utilizing the system of the present disclosure, detailed local information can be acquired instantly. The user wears earphones and contact lenses and acquires surrounding voice and visual information in real time while walking around the tourist spot. The voice acquisition unit clearly captures a guide's explanation and surrounding conversations, and the visual acquisition unit acquires high-resolution images of buildings and sculptures that the user gazes at.

When the user looks at a specific building and wants to know its historical background, the user utters a prompt orally, such as “Tell me the history of this building.” The prompt analysis unit analyzes this oral prompt and understands the user's intention. Based on the analysis result, the information generation unit refers to a database on the Internet and collects information about the history of the building. For a generative AI, a specific prompt sentence such as “Explain the construction year, architect, and historical significance of this building in detail” is used.

The information provision unit provides the generated information to the user. When the user selects information provision by voice, the history of the building is conveyed in a natural voice using synthesized speech technology through the earphones. When visual information provision is selected, the historical background of the building and related images are directly projected into the user's field of view using the retinal projection function of the contact lenses.

In this way, when visiting a tourist spot, the user can instantly acquire detailed local information and gain a deeper understanding. Furthermore, by repeating a similar process each time the user visits a different tourist spot, it becomes possible to efficiently accumulate knowledge about the history and culture of various places.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

An embodiment will be described more specifically and in detail. This system aims to monitor the state of a user in real time at a nursing care site and provide necessary information to nursing care staff. The system is composed of a terminal including earphones and contact lenses worn by the user, and a server that performs information processing.

First, a voice acquisition unit captures the user's surrounding voice in real time using a high-sensitivity microphone built into the earphones. This microphone can clearly acquire the user's utterances and environmental sounds. For example, when the user utters “Help,” the voice is immediately analyzed and the nursing care staff is notified. This notification is displayed on the staff's mobile terminal or a monitor in the facility, prompting a quick response. Also, by using noise canceling technology, noise in the facility is removed, and important voice information can be accurately acquired. Furthermore, the voice acquisition unit can analyze the tone and speed of the user's voice to detect signs of stress or anxiety. This allows the nursing care staff to grasp the user's emotional state and take appropriate action.

Next, a visual acquisition unit captures images entering the user's field of view in real time using a small camera built into the contact lenses. This camera can monitor the user's movements and facial expressions. For example, if the user is trying to get out of bed but loses balance and is about to fall, the image is analyzed and an alert is sent to the nursing care staff. This alert is displayed as an emergency notification on the staff's terminal, enabling prompt intervention. Also, by using eye-tracking technology, an object that the user is gazing at can be identified, and related information can be provided as needed. For example, if the user is looking at a medicine bottle, information about that medicine can be provided to the staff to prevent incorrect medication administration.

A prompt analysis unit analyzes the user's utterances using natural language processing technology and identifies necessary nursing care services. For example, when the user utters “It's time to take my medicine,” the prompt analysis unit analyzes the utterance and notifies the nursing care staff of information regarding the type of medicine and administration time. This analysis requires the use of machine learning algorithms to accurately understand the user's intention. Also, the prompt analysis unit can learn the user's utterance patterns and predict daily needs. For example, if the user utters “I want to have breakfast” at a specific time every morning, that pattern is learned and the staff is notified in advance, realizing smooth nursing care.

An information generation unit generates related nursing care information based on the analysis result from the prompt analysis unit. For example, an appropriate care plan can be generated based on the user's health condition and past medical history and provided to the staff. For a generative AI, detailed information is generated by using a specific prompt sentence such as “Propose an optimal care plan based on the user's current health condition.” Furthermore, the information generation unit can propose personalized nursing care services based on the user's lifestyle and preferences. For example, if the user has specific dietary restrictions, a meal plan based on those restrictions is generated and provided to the staff.

An information provision unit provides the generated information to the nursing care staff. In the case of information provision by voice, the information is conveyed to the staff in a natural voice using synthesized speech technology. In the case of visual information provision, the information is displayed on the staff's terminal, enabling a quick response. For example, if the user has a specific allergy, that information can be notified to the staff to prevent incorrect medication administration. Also, the information provision unit can prioritize and provide information to reduce the staff's workload. This allows the staff to concentrate on the most important information and perform their duties efficiently.

With this system, nursing care staff can grasp the user's condition in real time and take prompt and appropriate action. This makes it possible to improve the quality of care and ensure the user's safety and comfort. It also reduces the burden on staff and realizes the provision of more efficient nursing care services. Furthermore, the system can accumulate long-term health data of the user and use it for future care planning. This is expected to contribute to maintaining the user's health and improving their quality of life.

### (System Configuration)

The system according to the present embodiment includes a voice acquisition unit, a visual acquisition unit, a prompt analysis unit, an information generation unit, and an information provision unit. The voice acquisition unit has a built-in high-sensitivity microphone for capturing the user's surrounding voice in real time. This microphone can clearly acquire the user's utterances and environmental sounds. For example, when the user utters “Help,” the voice is immediately analyzed and the nursing care staff is notified. This notification is displayed on the staff's mobile terminal or a monitor in the facility, prompting a quick response. Also, by using noise canceling technology, noise in the facility is removed, and important voice information can be accurately acquired. Furthermore, the voice acquisition unit can analyze the tone and speed of the user's voice to detect signs of stress or anxiety. This allows the nursing care staff to grasp the user's emotional state and take appropriate action.

The visual acquisition unit uses a small camera built into contact lenses to capture images entering the user's field of view in real time. This camera can monitor the user's movements and facial expressions. For example, if the user is trying to get out of bed but loses balance and is about to fall, the image is analyzed and an alert is sent to the nursing care staff. This alert is displayed as an emergency notification on the staff's terminal, enabling prompt intervention. Also, by using eye-tracking technology, an object that the user is gazing at can be identified, and related information can be provided as needed. For example, if the user is looking at a medicine bottle, information about that medicine can be provided to the staff to prevent incorrect medication administration. Furthermore, the visual acquisition unit can analyze the user's facial expressions and infer their emotional state. This enables the staff to provide appropriate support when the user is feeling anxious or confused.

The prompt analysis unit analyzes the user's utterances using natural language processing technology and identifies necessary nursing care services. For example, when the user utters “It's time to take my medicine,” the prompt analysis unit analyzes the utterance and notifies the nursing care staff of information regarding the type of medicine and administration time. This analysis requires the use of machine learning algorithms to accurately understand the user's intention. Also, the prompt analysis unit can learn the user's utterance patterns and predict daily needs. For example, if the user utters “I want to have breakfast” at a specific time every morning, that pattern is learned and the staff is notified in advance, realizing smooth nursing care. Furthermore, the prompt analysis unit can analyze the content of the user's utterances and preferentially process urgent requests.

The information generation unit generates related nursing care information based on the analysis result from the prompt analysis unit. For example, an appropriate care plan can be generated based on the user's health condition and past medical history and provided to the staff. For a generative AI, detailed information is generated by using a specific prompt sentence such as “Propose an optimal care plan based on the user's current health condition.” Furthermore, the information generation unit can propose personalized nursing care services based on the user's lifestyle and preferences. For example, if the user has specific dietary restrictions, a meal plan based on those restrictions is generated and provided to the staff. Also, the information generation unit can analyze the user's long-term health data and predict future health risks.

The information provision unit provides the generated information to the nursing care staff. In the case of information provision by voice, the information is conveyed to the staff in a natural voice using synthesized speech technology. In the case of visual information provision, the information is displayed on the staff's terminal, enabling a quick response. For example, if the user has a specific allergy, that information can be notified to the staff to prevent incorrect medication administration. Also, the information provision unit can prioritize and provide information to reduce the staff's workload. This allows the staff to concentrate on the most important information and perform their duties efficiently. Furthermore, the information provision unit can flexibly change the method of providing information according to the user's condition. For example, if the user has a visual impairment, information provision by voice can be prioritized.

With this system, nursing care staff can grasp the user's condition in real time and take prompt and appropriate action. This makes it possible to improve the quality of care and ensure the user's safety and comfort. It also reduces the burden on staff and realizes the provision of more efficient nursing care services. Furthermore, the system can accumulate long-term health data of the user and use it for future care planning. This is expected to contribute to maintaining the user's health and improving their quality of life.

### (Implementation Steps)

### Step 1: Acquisition of Voice Information

The voice acquisition unit uses a high-sensitivity microphone to capture the user's surrounding voice in real time. This microphone can clearly acquire the user's utterances and environmental sounds. For example, when the user utters “Help,” the voice is immediately analyzed and the nursing care staff is notified. This notification is displayed on the staff's mobile terminal or a monitor in the facility, prompting a quick response. Also, by using noise canceling technology, noise in the facility is removed, and important voice information can be accurately acquired. Furthermore, the voice acquisition unit can analyze the tone and speed of the user's voice to detect signs of stress or anxiety.

### Step 2: Acquisition of Visual Information

The visual acquisition unit uses a small camera built into contact lenses to capture images entering the user's field of view in real time. This camera can monitor the user's movements and facial expressions. For example, if the user is trying to get out of bed but loses balance and is about to fall, the image is analyzed and an alert is sent to the nursing care staff. This alert is displayed as an emergency notification on the staff's terminal, enabling prompt intervention. Also, by using eye-tracking technology, an object that the user is gazing at can be identified, and related information can be provided as needed.

### Step 3: Analysis of Oral Prompt

The prompt analysis unit analyzes the user's utterances using natural language processing technology and identifies necessary nursing care services. For example, when the user utters “It's time to take my medicine,” the prompt analysis unit analyzes the utterance and notifies the nursing care staff of information regarding the type of medicine and administration time. This analysis requires the use of machine learning algorithms to accurately understand the user's intention. Also, the prompt analysis unit can learn the user's utterance patterns and predict daily needs.

### Step 4: Generation of Information

The information generation unit generates related nursing care information based on the analysis result from the prompt analysis unit. For example, an appropriate care plan can be generated based on the user's health condition and past medical history and provided to the staff. For a generative AI, detailed information is generated by using a specific prompt sentence such as “Propose an optimal care plan based on the user's current health condition.” Furthermore, the information generation unit can propose personalized nursing care services based on the user's lifestyle and preferences.

### Step 5: Provision of Information

The information provision unit provides the generated information to the nursing care staff. In the case of information provision by voice, the information is conveyed to the staff in a natural voice using synthesized speech technology. In the case of visual information provision, the information is displayed on the staff's terminal, enabling a quick response. For example, if the user has a specific allergy, that information can be notified to the staff to prevent incorrect medication administration. Also, the information provision unit can prioritize and provide information to reduce the staff's workload.

### (Specific Use Case)

For example, in a nursing care facility, by utilizing the system of the present disclosure, the safety and comfort of users can be improved. The user wears earphones and contact lenses, and during daily life, the voice acquisition unit and the visual acquisition unit constantly capture surrounding information. When the user utters “I want water,” the voice acquisition unit immediately analyzes the voice and notifies the nursing care staff. This notification is displayed on the staff's mobile terminal, prompting a quick response.

When the user is trying to get out of bed but loses balance and is about to fall, the visual acquisition unit captures the image in real time and sends an alert to the nursing care staff. This alert is displayed as an emergency notification on the staff's terminal, enabling prompt intervention. Also, when the user is looking at a medicine bottle, information about that medicine can be provided to the staff to prevent incorrect medication administration.

The prompt analysis unit analyzes the user's utterances and identifies necessary nursing care services. For example, when the user utters “I want to go for a walk today,” the prompt analysis unit analyzes the utterance and notifies the staff. This analysis requires the use of machine learning algorithms to accurately understand the user's intention.

The information generation unit generates an appropriate care plan based on the user's health condition and past medical history. For a generative AI, detailed information is generated by using a specific prompt sentence such as “Propose an optimal exercise plan based on the user's current health condition.” For example, if the user has specific exercise restrictions, an exercise plan based on those restrictions is generated and provided to the staff.

The information provision unit provides the generated information to the nursing care staff. In the case of information provision by voice, the information is conveyed to the staff in a natural voice using synthesized speech technology. In the case of visual information provision, the information is displayed on the staff's terminal, enabling a quick response. For example, if the user has a specific allergy, that information can be notified to the staff to prevent incorrect medication administration.

In this way, nursing care staff can grasp the user's condition in real time and take prompt and appropriate action. This makes it possible to improve the quality of care and ensure the user's safety and comfort. It also reduces the burden on staff and realizes the provision of more efficient nursing care services. Furthermore, the system can accumulate long-term health data of the user and use it for future care planning. This is expected to contribute to maintaining the user's health and improving their quality of life.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

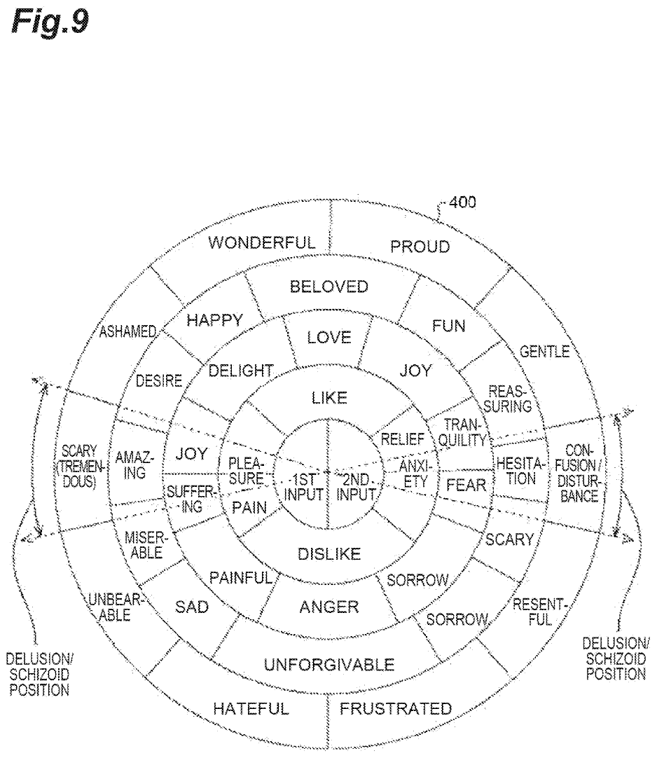

In the answer generation process in the data generation model 58, the emotion estimation result by the emotion identification model 59 functions as a parameter for prompt engineering. Specifically, when the coordinates (emotion value) on the emotion map 400 shown in FIG. 9 are identified, the specific processing unit 290 dynamically rewrites the system prompt (System Prompt) based on the coordinates. For example, if it is determined that the user's emotion is in the area of “Anxiety”, a constraint (Constraint) such as “Make the tone of the answer empathetic and concise, and explain avoiding technical terms” is added to the input prompt to the generative AI. Conversely, if the emotion is in the area of “Desire” or “Interest”, a constraint such as “Provide detailed and comprehensive information and include relevant suggestions” is added. In this way, this system not only simply searches for and outputs information, but also has a control structure that incorporates internal state variables derived from the user's biological reactions (voice tone, facial expression, pulse, etc.) as a feedback loop to optimize the quality and format of output information in real time.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

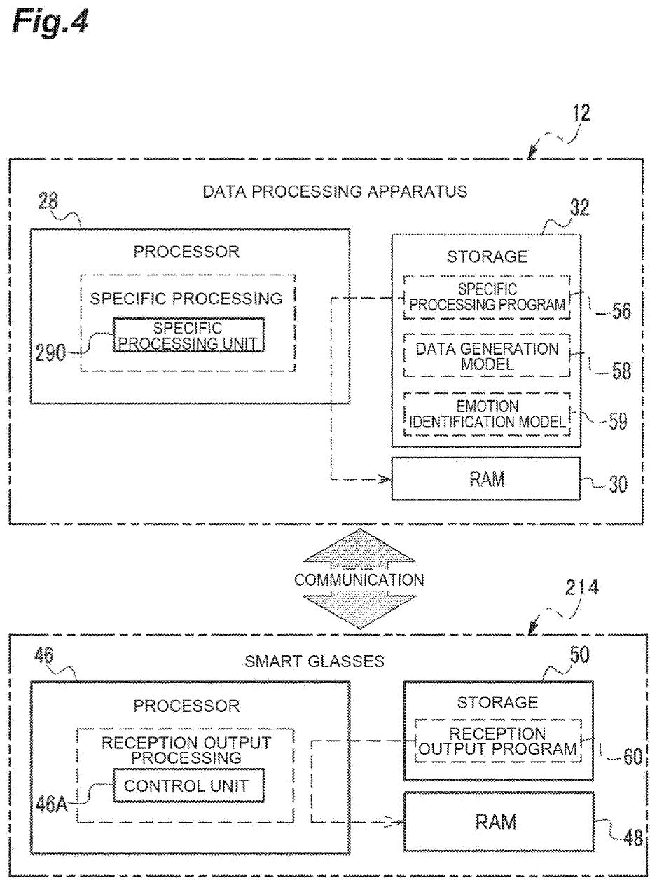

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### EXAMPLE 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

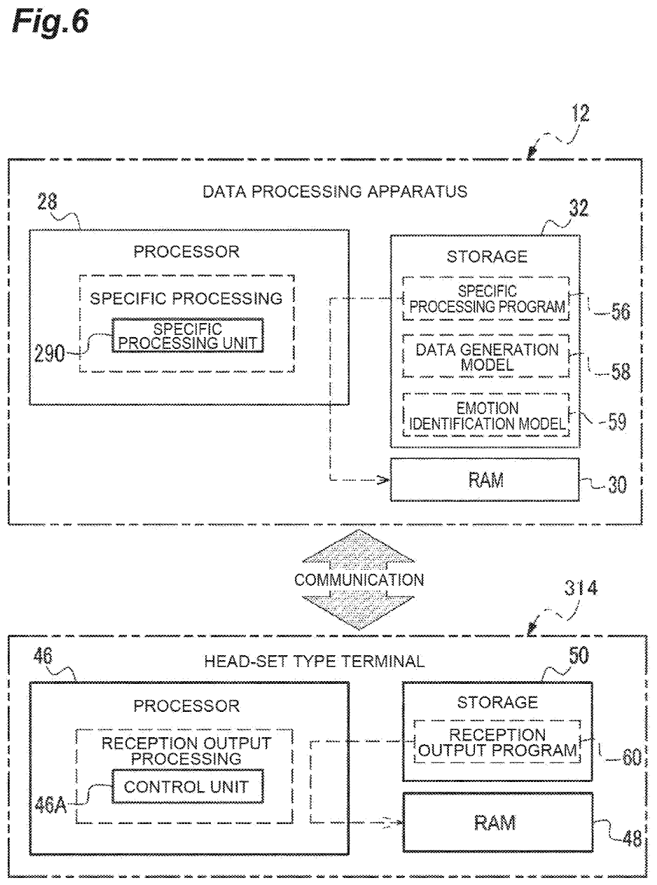

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### EXAMPLE 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

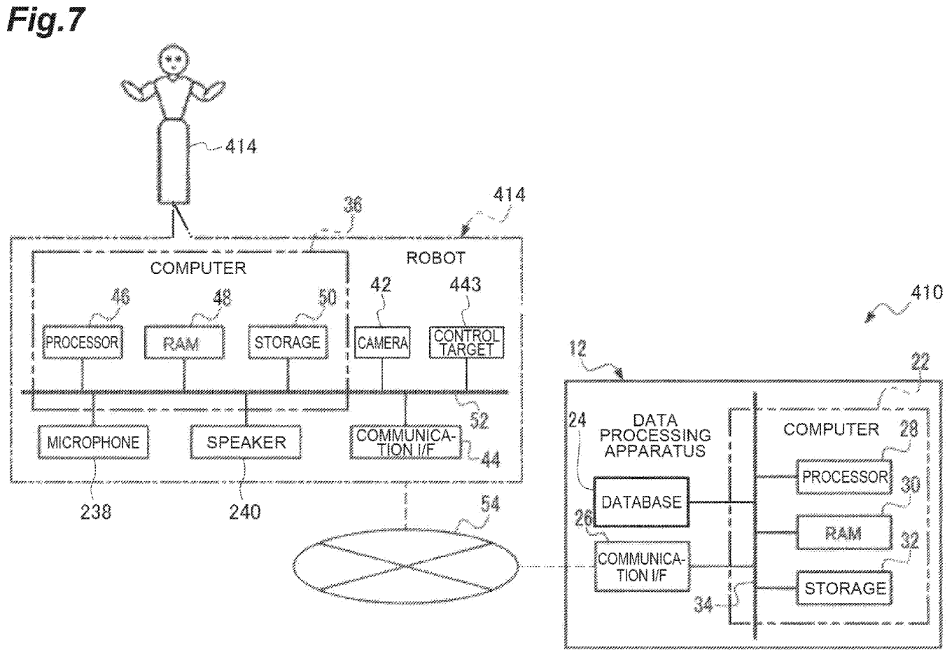

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

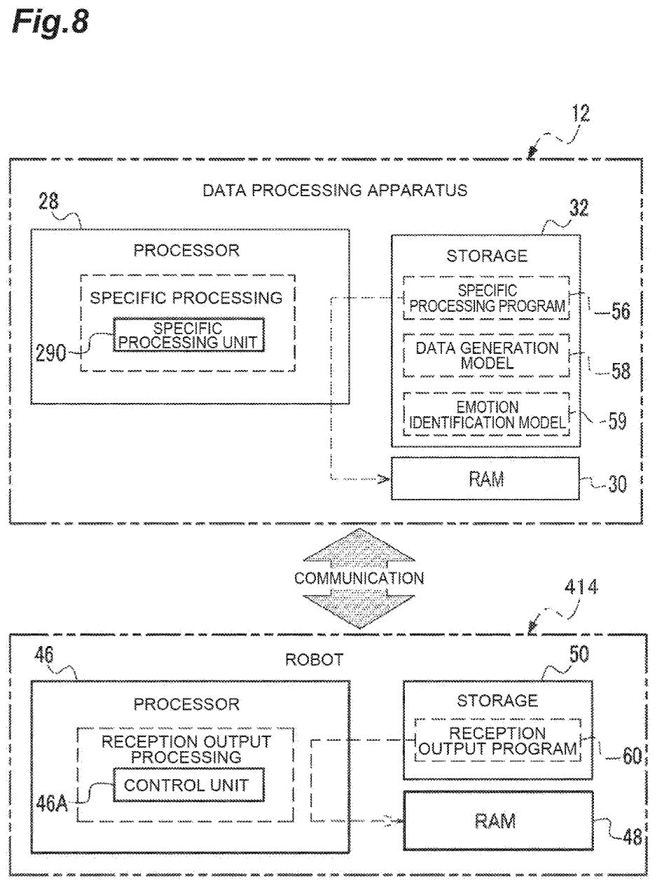

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### EXAMPLE 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

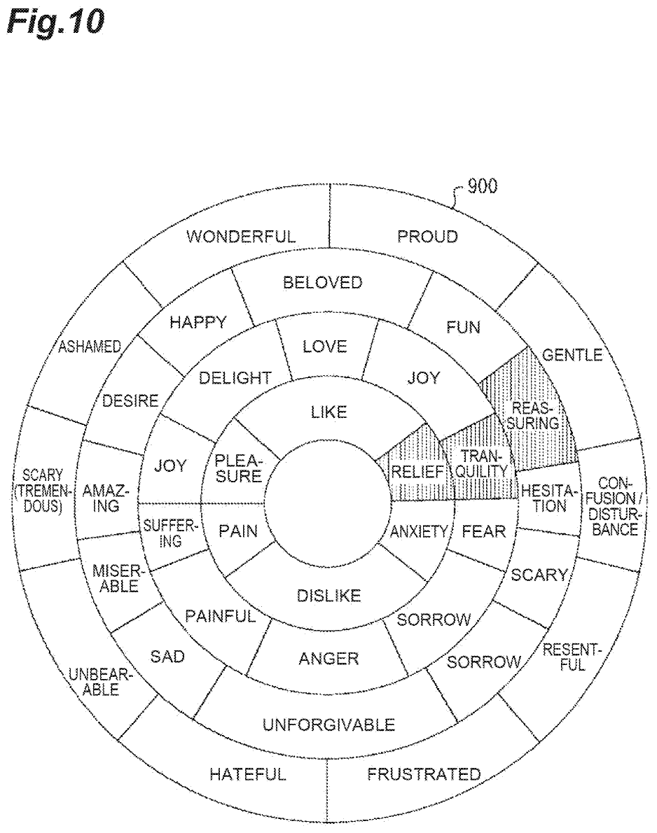

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

The determination of the emotion value in the emotion identification model 59 is performed by distance calculation in a multidimensional vector space. Specifically, the user's voice features (pitch, speed, intonation) and facial expression features (degree of opening and closing of eyes and mouth, movement of the glabella) are mapped to a multidimensional space, and the Euclidean distance or cosine similarity with the centroid (Centroid) of each emotion class defined on the emotion map 400 in FIG. 9 is calculated. If the calculated distance is within a predetermined threshold, the emotion class is identified as the user's current emotion. Furthermore, the system tracks the trajectory of emotions over time (Trajectory), and if a sudden emotional change (e.g., transition from “relief” to “fear”) is detected, the system shifts to an emergency mode and executes interrupt processing (Interrupt Processing) to immediately interrupt the output by the information provision unit or switch to a warning display. This interrupt processing is realized by priority control at the hardware level, and the highest priority is assigned in the OS task scheduler.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system including a voice acquisition unit, a visual acquisition unit, a prompt analysis unit, an information generation unit, and an information provision unit. The voice acquisition unit captures surrounding voice of a user in real time using a high-sensitivity microphone and removes unnecessary sound using noise canceling technology. The visual acquisition unit captures images entering a user's field of view in real time using a small camera built into contact lenses and identifies an object that the user is gazing at using eye-tracking technology. The prompt analysis unit analyzes a user's utterance using natural language processing technology and identifies a necessary nursing care service. The information generation unit generates related nursing care information based on the analysis result, and the information provision unit provides the generated information to nursing care staff.

The system, wherein the voice acquisition unit clearly acquires a user's utterances and environmental sounds and transmits them to a server using wireless communication technology such as Bluetooth or Wi-Fi. The visual acquisition unit has a function of monitoring a user's movements and facial expressions, analyzing an image when the user falls, and sending an alert to nursing care staff.

The system, wherein the prompt analysis unit analyzes a user's utterance and notifies nursing care staff of information regarding a type of medicine and an administration time. The information generation unit generates an appropriate care plan based on the user's health condition and past medical history, and uses a specific prompt sentence for a generative AI, such as “Propose an optimal care plan based on the user's current health condition.”

An information provision system comprising: a circuit, wherein the circuit is configured to: acquire voice information; acquire visual information; analyze a prompt orally input from a user; generate output information based on a result of the analysis; and provide the generated output information to the user.

The information provision system, further comprising a microphone, wherein the circuit is configured to: control the microphone so that the microphone captures surrounding voice in real time; and acquire the voice captured by the microphone as the voice information.

The information provision system, wherein the circuit is configured to: remove unnecessary sound included in the voice information based on noise canceling technology.

The information provision system, further comprising a camera, wherein the circuit is configured to: control the camera so that the camera captures an image entering a field of view of the user in real time; and acquire the image captured by the camera as the visual information.

The information provision system, wherein the camera is configured to follow eye movements of the user.

The information provision system, further comprising a display, wherein the circuit is configured to: control the display so that the display projects the output information onto a retina of the user.

An information provision method comprising: acquiring voice information; acquiring visual information; analyzing a prompt orally input from a user; generating output information based on a result of the analysis; and providing the generated output information to the user.

1. An information provision system comprising:
a circuit,
wherein the circuit is configured to:
acquire voice information;
acquire visual information;
analyze a prompt orally input from a user;
generate output information based on a result of the analysis; and
provide the generated output information to the user.

2. The information provision system according to claim 1,
further comprising a microphone,
wherein the circuit is configured to:
control the microphone so that the microphone captures surrounding voice in real time; and
acquire the voice captured by the microphone as the voice information.

3. The information provision system according to claim 1,
wherein the circuit is configured to:
remove unnecessary sound included in the voice information based on noise canceling technology.

4. The information provision system according to claim 1,
further comprising a camera,
wherein the circuit is configured to:
control the camera so that the camera captures an image entering a field of view of the user in real time; and
acquire the image captured by the camera as the visual information.

5. The information provision system according to claim 4,
wherein the camera is configured to follow eye movements of the user.

6. The information provision system according to claim 1,
further comprising a display,
wherein the circuit is configured to:
control the display so that the display projects the output information onto a retina of the user.

7. An information provision method comprising:
acquiring voice information;
acquiring visual information;
analyzing a prompt orally input from a user;
generating output information based on a result of the analysis; and
providing the generated output information to the user.
